(19) United States
(12) Patent Application Publication
(10) Pub. No.: US 2026/0211401 A1
(43) Pub. Date: Jul. 23, 2026

(54) SYSTEM AND METHOD FOR CALCULATING FLARE EFFICIENCY

(71) Applicant: Honeywell International Inc., Charlotte, NC (US)

(72) Inventors: Aishwarya Coffey, Dublin (IE); Sahil Vartak, Atlanta, GA (US); Sabina Azizli, Fulshear, TX (US); Junda Zhu, Atlanta, GA (US); Tarun Mirani, Decatur, GA (US); Shahrul Azman Bin Zainal Abidin, Kuala Lumpur (MY)

(21) Appl. No.: 19/032,133

(22) Filed: Jan. 20, 2025

(51) Int. Cl. G05B 19/418

(52) U.S. Cl. CPC G05B 19/4184; G05B 19/41885

(57) ABSTRACT

Various embodiments described herein relate to managing flare efficiency reporting corresponding to a plurality of flare stacks in a facility. In this regard, real-time flare data is received from at least one flare stack of the plurality of flare stacks. As a result, fuel coefficients A and B are determined for the flare gas based on the real-time flare data, using a trained Artificial Intelligence/Machine Learning (AI/ML) model. Accordingly, a Destruction and Removal Efficiency (DRE) corresponding to the at least one flare stack is predicted based at least on the fuel coefficients A and B and the one or more operational parameters, using the AI/ML model. Further, real-time recommendations are generated using the AI/ML to maintain the DRE above a predetermined threshold when the predicted DRE falls below the predetermined threshold.

### TECHNICAL FIELD

Embodiments of the present disclosure relate generally to systems, apparatuses, methods, and computer program products for managing flare efficiency reporting corresponding to one or more flare stacks in a facility.

### BACKGROUND

Oil Gas Methane Partnership (OGMP) methodology was designed in 2014 under the UNEP-led Climate and Clean Air Coalition's (CCAC's) Mineral Methane Initiative (MMI) and is a multi-stakeholder partnership that brings together oil and gas companies, international organizations, government, and NGOs to improve accuracy and transparency of reporting of methane emissions. The goal is to drive deep methane reductions across the industry, guided by actionable emissions data, in a manner transparent to governments, civil society and investors. OGMP 2.0 mandates its members to provide accurate annual flare efficiency reports. Improving flare efficiency is crucial for minimizing the environmental impact of oil and gas operations, particularly regarding methane, a greenhouse gas. Enhanced understanding of flare efficiency is crucial for driving continuous improvement in emissions management practices across the sector. To support this initiative, each site is required to monitor and report their emissions on a regular basis. However, this process currently relies on manual efforts by site engineers, which may be time-consuming and prone to errors, particularly when dealing with noisy data that makes it difficult to notice baseline changes in emissions. Additionally, tracking the flare amount against regulatory requirements is challenging, further complicating compliance efforts. Traditional flaring analyzers may not be reliable and often require significant maintenance, which may lead to inconsistencies in data collection and reporting. These issues underscore the need for more robust, automated solutions to improve data accuracy and facilitate better decision-making in managing flare efficiency reporting.

### SUMMARY

The details of some embodiments of the subject matter described in this specification are set forth in the accompanying drawings and the description below. Other features, aspects, and advantages of the subject matter will become apparent from the description, the drawings, and the claims.

In accordance with an embodiment of the present disclosure, a system for managing flare efficiency reporting corresponding to a plurality of flare stacks in a facility is described. The system comprises a memory and at least one processor communicatively coupled to the memory. The at least one processor receives real-time flare data from at least one flare stack of the plurality of flare stacks, wherein the real-time flare data includes fuel composition data corresponding to a flare gas in the at least one flare stack and one or more operational parameters associated with operation of the at least one flare stack, determines, using a trained Artificial Intelligence/Machine Learning (AI/ML) model, fuel coefficients A and B for the flare gas based on the real-time flare data, wherein the fuel coefficients A and B are specific to the fuel composition data and a lower heating value (LHV) of the flare gas, predicts, using the trained AI/ML model, a Destruction and Removal Efficiency (DRE) corresponding to the at least one flare stack based at least on the fuel coefficients A and B and the one or more operational parameters, and generates, using the trained AI/ML model, real-time recommendations to maintain the DRE above a predetermined threshold when the predicted DRE falls below the predetermined threshold.

In accordance with an example embodiment, a method for managing flare efficiency reporting corresponding to a plurality of flare stacks in a facility is described. The method comprises receiving real-time flare data from at least one flare stack of the plurality of flare stacks, wherein the real-time flare data includes fuel composition data corresponding to a flare gas in the at least one flare stack and one or more operational parameters associated with operation of the at least one flare stack, determining, using a trained Artificial Intelligence/Machine Learning (AI/ML) model, fuel coefficients A and B for the flare gas based on the real-time flare data, wherein the fuel coefficients A and B are specific to the fuel composition data and a lower heating value (LHV) of the flare gas, predicting, using the trained AI/ML model, a Destruction and Removal Efficiency (DRE) corresponding to the at least one flare stack based at least on the fuel coefficients A and B and the one or more operational parameters, and generating, using the trained AI/ML model, real-time recommendations to maintain the DRE above a predetermined threshold when the predicted DRE falls below the predetermined threshold.

The above summary is provided merely for purposes of providing an overview of one or more exemplary embodiments described herein so as to provide a basic understanding of some aspects of the disclosure. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which are further explained in the following description and its accompanying drawings.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF DRAWINGS

The accompanying drawings, which are incorporated in and constitute a part of this specification, illustrate various exemplary embodiments and together with the description, serve to explain the principles of the disclosed embodiments, in which:

FIG. 1 illustrates a network diagram of a system for managing flare efficiency reporting using a trained Artificial Intelligence/Machine Learning (AI/ML) model in accordance with an example embodiment of the present disclosure;

FIG. 2 illustrates a block diagram of a server of the system in accordance with an example embodiment of the present disclosure;

FIG. 3 illustrates a block diagram showing different stages of the system for managing the flare efficiency reporting in accordance with an example embodiment of the present disclosure;

FIG. 4 illustrates a block diagram of a controller of the system in accordance with an example embodiment of the present disclosure; and

FIG. 5 illustrates a detailed flowchart showing a method for managing the flare efficiency reporting corresponding to one or more flare stacks in accordance with an example embodiment of the present disclosure.

FIG. 6 illustrates an exemplary scenario of an industrial setting having the one or more flare stacks in accordance with an example embodiment of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described example embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments. The term “or” is used herein in both the alternative and conjunctive sense, unless otherwise indicated. The terms “illustrative,” “example,” and “exemplary” are used to be examples with no indication of quality level. Like numbers refer to like elements throughout.

The phrases “in an embodiment,” “in one embodiment,” “according to one embodiment,” and the like generally mean that the particular feature, structure, or characteristic following the phrase may be included in at least one example embodiment of the present disclosure, and may be included in more than one example embodiment of the present disclosure (importantly, such phrases do not necessarily refer to the same example embodiment).

The word “exemplary” is used herein to mean “serving as an example, instance, or illustration.” Any implementation described herein as “exemplary” is not necessarily to be construed as preferred or advantageous over other implementations. If the specification states a component or feature “can,” “may,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some example embodiments, or it may be excluded.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

OGMP 2.0 mandates its members to provide accurate annual flare efficiency reports. Flare efficiency measures the effectiveness of flare stacks in combusting gases, particularly in reducing harmful emissions. It is typically expressed as a percentage, representing the proportion of gas that is successfully burned compared to the total amount of gas sent to the flare. Flare stacks, also known as flare booms or flare pits, are gas combustion devices used in various industrial settings such as petroleum refineries, chemical plants, natural gas processing plants, and oil or gas extraction sites. They are designed to safely burn off flammable gases released by safety valves during unplanned over pressuring of plant equipment, as well as during plant startups, shutdowns, and maintenance activities. High flare efficiency indicates that a significant amount of the gas is being combusted completely, resulting in lower emissions of pollutants like methane and volatile organic compounds (VOCs). Conversely, low flare efficiency means that a portion of the gas may be released into the atmosphere unburned, contributing to greenhouse gas emissions. By accurately reporting the flare efficiency, organizations gain valuable insights into their operations, enabling them to identify opportunities for reducing methane emissions. This not only supports their efforts to meet climate targets but also fosters transparency and accountability within the industry, ultimately aiding in the minimization of environmental impacts. Improving flare efficiency in facilities is crucial for minimizing the environmental impact of oil and gas operations, particularly regarding methane emissions. Enhanced understanding of flare efficiency is crucial for driving continuous improvement in emissions management practices across the sector.

The Zero Routine Flaring (ZRF) Initiative, launched in 2015, is a commitment by government and oil companies to eliminate routine flaring. Routine flaring contributes significantly to climate change through pollutant emissions and energy wastage, making its reduction a critical goal for environmental sustainability. To support this initiative, each site is required to monitor and report their emissions on a regular basis. However, this process currently relies on manual efforts by site engineers, which may be time-consuming and prone to errors, particularly when dealing with noisy data that makes it difficult to notice baseline changes in emissions. Additionally, tracking the flare amount against regulatory requirements is challenging, further complicating compliance efforts. Traditional flaring analyzers may not be reliable and often require significant maintenance, which may lead to inconsistencies in data collection and reporting. These issues underscore the need for more robust, automated solutions to improve data accuracy and facilitate better decision-making in managing flaring events.

According to MMI OGMP 2.0 framework, organizations and individual assets may be at different stages of their methane management and reporting journeys. The OGMP 2.0 acknowledges this fact and allows companies to categorize their asset-level reporting by 5 distinct reporting levels. The reporting levels are based upon 1. Reporting granularity, both at the level of sources and geography (i.e. global, simplified consolidation categories, detailed source type and/or by region/country/asset) 2. Quantification methodologies (e.g. generic and source specific emissions factors, engineering calculations, simulations, direct measurement, etc.) 3. Uncertainty in the quantification (i.e., emission factors, direct measurements, and complementary reconciliation monitoring processes, e.g. site-level measurements). The five OGMP 2.0 reporting levels: Level 1—Emissions reported for a venture at asset or country level (i.e. one methane emissions figure for all operations in an asset or all assets within a region or country). It is applicable where the organization has very limited information. Level 2—Emissions reported in consolidated, simplified sources categories (based on IOGP's 5 emissions categories for upstream, and MARCOGAZ′ 3 emissions categories for mid and downstream), using a variety of quantification methodologies, progressively up to the asset level, when available. Level 3—Emissions reported by detailed source type and using generic emission factors (EFs). Level 4—Emissions reported by detailed source type and using specific EFs and activity factors (AFs). Source-level measurement and sampling may be used as the basis for establishing these specific EFs and AFs, though other source specific quantification methodologies such as simulation tools and detailed engineering calculations (e.g. as referenced in existing OGMP TGDs) may be used where appropriate. Level 5—Emissions reported similarly to Level 4, but with the addition of site-level measurements (measurements that characterize site-level emissions distribution for a statistically representative population).

Currently, many companies rely on generic formulas to estimate their Level 3 emissions, which may lead to less accurate reporting. Level 3 reporting typically relies on generic emissions factors and assumptions. This approach uses predefined data and coefficients based on average conditions and typical fuel compositions. While useful for initial estimates, Level 3 reporting is less precise because it doesn't account for site-specific conditions or variations in fuel composition. It is commonly used for preliminary assessments or in situations where detailed data is unavailable. Level 3 reporting makes assumptions about the fuel composition. However, Level 4 reporting accurately determines the fuel composition using direct measurements of emissions and operational parameters, providing a more accurate representation of actual performance. This can include methods like real-time monitoring of flare efficiency and fuel composition analysis. Level 4 reporting offers significantly higher accuracy by utilizing specific data from the site and advanced technologies, such as sensors and machine learning (ML) models. As a result, Level 4 reporting is employed for compliance reporting, detailed environmental assessments, and continuous improvement initiatives. Therefore, there is a need to elevate reporting from Level 3 to Level 4 that involves moving toward a more detailed and precise approach.

Traditional Destruction and removal efficiency (DRE) calculations rely on static fuel coefficients (A, B, LHV), which are often assumed rather than derived from actual data, potentially leading to inaccuracies. Below provided is a formula that is used to calculate DRE per flare stack in Level 3 reporting involves fuel coefficients such as A, B, and LHV

DRE=Func (A, B, LHV, U, V, d),
where A, B, LHV are fuel coefficients, U is windspeed, V is flare flow velocity, d is the flare stack diameter.

The fuel coefficients A and B are often assumed rather than scientifically derived. This could certainly lead to inaccuracies in reporting and analysis. Further, the traditional method of calculating level 4 destruction and removal efficiency (DRE) includes using camera such as the Sensia Redlook Agni camera which is pointed at a flare stack. The camera is used to monitor the flare stack allows for real-time analysis of combustion efficiency. The camera uses image processing techniques to determine how efficiently the flare stack destroys the fuel. However, the cost of the hardware in the camera is very high.

Therefore, there is a need to enhance management of flaring efficiency reporting. By implementing automated systems, organizations may effortlessly understand the causes behind flaring events without the need to sift through extensive incident reports or construct multiple trends manually. This approach allows for daily automated reporting on flared volumes, enabling seamless comparisons against permitted thresholds and ensuring compliance with regulations. Additionally, real-time analysis may identify any changes in routine flaring patterns, such as leaking valves or other operational issues. This not only improves efficiency but also enhances safety and environmental accountability, providing organizations with the insights needed to take proactive measures and reduce unnecessary flaring.

In an aspect, the present disclosure provides a significant advancement in flare efficiency reporting by enhancing accuracy from level 3 reporting to level 4 reporting. The present invention aims to enhance the accuracy and reliability of Destruction and Removal Efficiency (DRE) calculations for flare stacks by transitioning from generic emissions factors (Level 3) to direct measurements (Level 4), using real-time data and Artificial Intelligence (AI)/ Machine Learning (ML) model. The present invention focuses on dynamic calculation of fuel coefficients A, B, and Lower Heating Value (LHV), the integration of air-assisted flare flow and steam-assisted flare flow, and the use of the AI/ML model to optimize these calculations.

In another aspect, the present invention uses advanced machine learning (ML) algorithms to dynamically calculate fuel coefficients A and B based on real-time data from flare stack operations. These fuel coefficients may vary depending on fuel composition, LHV, and operational conditions. The present invention aims at optimizing fuel coefficients A and B in Level 4 reporting. The values of fuel coefficients A and B are calculated directly, the focus on data-driven methods can help further refine the accuracy of DRE assessments. This approach can reduce uncertainties and improve compliance with regulatory standards. In the short term, the AI/ML model such as Xgboost is trained using ground truth DRE data obtained from one or more flare stack cameras (such as the Sensia Redlook Agni camera) and simulated data to optimize fuel coefficients A and B and accordingly, predict the DRE for one or more flare stacks. The ground truth DRE data for the one or more flare stacks is collected to train the AI/ML model. Air assisted flow rates and steam assisted flow rates with varying LHVs are further utilized to train the AI/ML model. A combination of the camera data and the simulated data from first principle physics-based model is used to optimize fuel coefficients A and B and predict the DRE for the one or more flare stacks. Further, the AI/ML model may analyze historical data on fuel flow and operational conditions, such as any assistance provided to the flare (like additional oxidizers or adjustments in operation). The historical data includes the amount of fuel that is sent to the flare, flare stack performance, and environmental conditions. Computer vision techniques are used to analyze images from the flare stack, assessing factors like flame characteristics and combustion quality. For different fuel compositions, the values of fuel coefficients A and B are different. Also, for different Lower Heating Values (LHVs), there are different fuel coefficients A and B. These fuel coefficients A and B are the optimized fuel coefficients for the respective LHVs.

In the long term, once enough data has been gathered for various flare stacks having different diameters, the AI/ML model is trained for each individual flare stack based on unique parameters (diameter, windspeed, flare flow velocity, air-assisted flow velocity, steam-assisted flow velocity, environmental conditions) to predict the DRE using optimized fuel coefficients A and B and a universal AI/ML model could be developed. This model will be applicable across different flare stacks without the need for constant camera data, as it will learn patterns based on the historical data, including operational variables like fuel flow, wind speed, flare stack diameter, and assistance factors (air and steam). A lookup table could be created for different values of fuel coefficients A and B corresponding to different LHVs. This AI/ML model will adjust the DRE predictions dynamically based on real-time data from ongoing operations, enabling continuous optimization without manual input. This approach allows for real-time DRE calculation based on ongoing data, eliminating the need for expensive hardware in the long term. The AI/ML model analyzes factors such as wind speed (U), flare flow velocity (V), air-assisted flow velocity (Va), and steam-assisted flow velocity (Vs) to predict the DRE per flare stack.

In yet another aspect, the present invention factors in air-assisted flow and steam-assisted flow in the DRE prediction. Air and steam assistance mechanisms significantly influence combustion efficiency by improving the combustion of the flare gas and, consequently, the types and quantities of pollutants emitted during flaring. Air and steam assistance enhance the combustion process by introducing additional oxygen and aiding in more complete burning of the flare gas. This leads to better destruction efficiency, which is essential for more accurate emission calculations. By integrating these factors into the AI/ML model, the present invention may learn to adjust for the impact of air/steam mixtures on combustion, helping to predict emissions more reliably. Additionally, air and steam assistance contribute to stabilizing the flare flame, even under challenging weather conditions like strong winds, where without such assistance, flames could be extinguished or fluctuating. This stability helps maintain consistent emissions data, which is crucial for accurate reporting and emissions reduction strategies. Ultimately, the improved combustion efficiency and enhanced flare stability may significantly reduce methane emissions, supporting better emissions management practices and aligning with broader sustainability goals in the industry. By considering these factors, the present invention may enable prediction of the DRE more accurately, accounting for the impact of these variables on fuel destruction efficiency. The inclusion of air and steam assistance factors is critical in the measurement process allows for a more comprehensive understanding regarding impact of flaring operations on emissions.

In yet another aspect of the present invention, in Level 4 reporting,

DRE=MLFunc (A, B, LHV, U, V, Va, Vs, d),
where A, B, and LHV are fuel coefficients, U is windspeed, V is flare flow velocity, Va is air-assisted flow velocity, Vs is steam-assisted flow velocity, and d is flare stack diameter.

In yet another aspect of the present invention, the AI/ML model may be integrated into the system to provide real-time recommendations for optimizing combustion efficiency by adjusting parameters such as steam and air-assisted flow. The present invention monitors the DRE continuously and suggest operational changes to keep DRE above optimal thresholds. For example, if DRE falls below a certain threshold, the AI/ML model may suggest varying feature values and find the appropriate feature combination that would improve combustion efficiency and bring DRE back to optimal levels. In one example, the certain threshold could be 98%. Consider a scenario where a flare stack experiences a drop in DRE below a preset threshold. The AI/ML model might recommend adjusting steam flow to 400 kg/h and air flow to 500 kg/h based on the historical data and real-time feedback. As a result, DRE increases, bringing it back to an optimal range. This proactive optimization helps ensure consistent, efficient flare operation and reduced emissions.

In yet another aspect of the present invention, by transitioning to a data-driven approach that uses AI/ML to optimize fuel coefficients and integrate additional operational factors (like air and steam assistance), the present invention improves the accuracy and reliability of DRE calculations in Level 4 reporting. The AI/ML model learn patterns that correlate fuel characteristics with DRE outcomes. The AI/ML model is implemented to provide real-time DRE predictions based on ongoing data inputs from the flare stack. The AI/ML model is continuously improved by integrating new data and outcomes to refine accuracy over time. By optimizing the fuel coefficients, the present invention captures the dynamic nature of combustion processes more accurately. Over time, it reduces the need for expensive equipment (like cameras) and enables ongoing improvements in flare stack efficiency, leading to better emissions management, cost savings, and regulatory compliance. The AI/ML model's ability to adapt and learn from new data ensures that this system will continually improve and provide long-term operational benefits across the industry. As more operational data is collected, the AI/ML model continues to improve, providing more accurate and reliable predictions. Over time, the AI/ML model learns from new data, fine-tuning its calculations to better reflect real-world flare performance. The AI/ML approach eliminates the need for constant manual intervention or costly camera systems after the initial setup phase. The model can be used to optimize flare performance continuously, reducing methane emissions and improving regulatory compliance while also driving operational efficiency. Instead of fixed values for A and B, the present invention calculates the fuel coefficients dynamically based on real-time data and historical performance, improving accuracy and reliability. The integration of steam and air-assisted flow into the DRE calculations acknowledges the effects these have on combustion efficiency. This is a major advancement over Level 3 reporting, where such factors are typically not considered. Utilizing AI/ML approach not only enhances the accuracy of the calculations but also allows for continuous improvement of the model. As new data is gathered, the model can adapt and refine its predictions, leading to better compliance and operational efficiency. These innovations can significantly enhance the reporting's reliability and provide a more comprehensive understanding of flare efficiency.

The present disclosure provides various embodiments of methods and systems for managing flaring efficiency reporting using an Artificial Intelligence/Machine Learning (AI/ML) model. Embodiments may be configured to receive real-time flare data from one or more flare stacks by at least one processor. The one or more flare stacks includes one or more sensors to collect the real-time flare data. The real-time flare data may correspond to fuel composition data corresponding to a flare gas and one or more operational parameters associated with an operation of the one or more flare stacks. The one or more operational parameters include wind speed (U), a flare flow velocity (V), an air-assisted flow velocity (Va), a steam-assisted flow velocity (Vs), and one or more operational conditions. The one or more operational conditions include mass or volume of gas flared within each of the one or more flare stacks, temperature of the gas flared, and pressure at which the gas is flared. Embodiments may be configured to determine, using a trained Artificial Intelligence/Machine Learning (AI/ML) model, fuel coefficients A and B based on the real-time flare data. The fuel coefficients A and B are specific to the fuel composition data and the lower heating value (LHV) of the flare gas. Embodiments may be configured to predict, using the trained AI/ML model, a Destruction and Removal Efficiency (DRE) of the at least one flare stack based on the fuel coefficients A and B and the one or more operational parameters. The DRE is a function of the fuel coefficients A and B, the lower heating value (LHV), the wind speed (U), the flare flow velocity (V), the air-assisted flow velocity (Va), the steam-assisted flow velocity (Vs) and the flare stack diameter (d). Embodiments may be configured to generate, using the trained AI/ML model, real-time recommendations to adjust the one or more operational parameters to maintain the DRE above a predetermined threshold when the predicted DRE falls below the predetermined threshold.

Embodiments may be configured to collect historical data and ground truth DRE data from one or more flare stack cameras and simulated data from a first principle physics-based model, determine optimized fuel coefficients A and B corresponding to different LHVs based on the collected historical data, the ground truth DRE data, and the simulated data, generate lookup table including the optimized fuel coefficients A and B corresponding to the different LHVs, and train the AI/ML model based on the collected historical data, the ground truth DRE data, the simulated data, and the lookup table to generate the trained AI/ML model. The historical data may correspond to a repository of the flare data received from each of the one or more flare stacks within a predefined time period. The historical data includes fuel flow data, one or more operational parameters such as air-assisted flow rate, steam-assisted flow rate with varying LHVs, flare stack performance, one or more operational conditions, emission data, the fuel composition data, combustion data corresponding to each of the one or more flare stacks. The one or more flare stacks can be of different diameters or similar diameters. The AI/ML model is trained to learn patterns from the real-time flare data, the historical data, the ground truth DRE data, the simulated data, and the lookup table corresponding to the one or more flare stacks. Embodiments may be configured to generate one or more alerts when the DRE falls below the predetermined threshold.

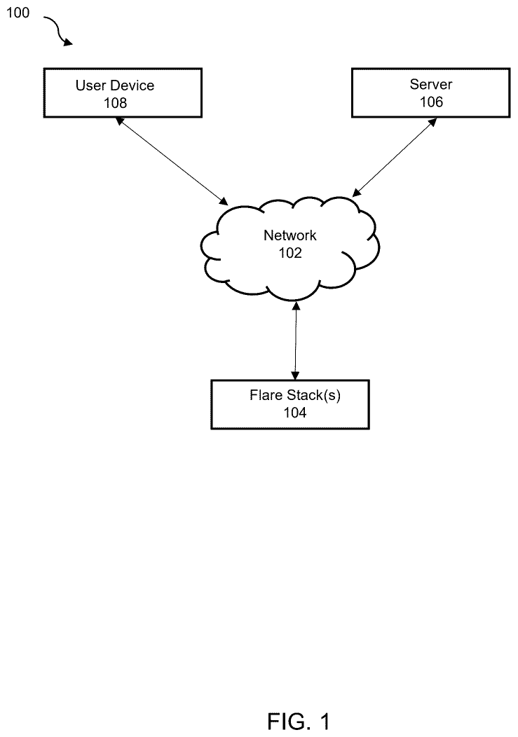

FIG. 1 illustrates a network diagram of a system 100 for managing flaring efficiency reporting using the Artificial Intelligence/Machine Learning (AI/ML) model, in accordance with an example embodiment of the present disclosure. The system 100 may comprise a network 102 and one or more flare stacks 104. The system 100 may further comprise a server 106 and a user device 108.

In some embodiments, the network 102 may be a communication network, such as the Internet or a cloud network, configured to enable communication between various computing devices and processing systems through wired, wireless, or hybrid connections. Further, the network 102 may also correspond to a distributed infrastructure designed for the exchange of data, information, and resources among interconnected computing devices and systems. The network 102 may facilitate communication and collaboration across remote locations, devices, and platforms. Those skilled in the art will understand that wired networks may include, but are not limited to, wired networks such as wide area networks (WANs) or local area networks (LANs). Further, wireless networks, on the other hand, may use wireless communications via radio frequency (RF) signals or infrared signals. Furthermore, various devices within the system 100 may connect to the network 102 using an array of wired and wireless communication protocols, such as Transmission Control Protocol/Internet Protocol (TCP/IP), User Datagram Protocol (UDP), and 2G, 3G, or 4G communication protocols.

Further, the one or more flare stacks 104 may be installed within an industrial setting (not shown). In some embodiments, the industrial setting may comprise one or more facilities that are designed to transform raw materials into finished goods. In some embodiments, the one or more facilities utilize one or more processes to transform the raw materials into the finished goods. Further, the one or more processes include, but are not limited to, manufacturing, refining, and chemical production. Further, during the transformation of the raw materials into the finished goods, a plurality of remains may be generated. Further, the plurality of remains may correspond to one or more gases. In some embodiments, when the plurality of remains exceed a predefined threshold, the industrial setting undergoes through a process that may be termed as flaring.

In some embodiments, the one or more flare stacks 104 may be configured to perform the flaring of the one or more gasses. Further, the flaring may refer to a process of controlled burning of excess one or more gases. In some embodiments, the one or more flare stacks 104 comprises one or more components (not shown) that may be configured to perform flaring of the one or more gases. Further, the one or more components may comprise a gas collection unit, flare header, knockout drum, flare tip, pilot burner, steam or air injection system, flame arrestor, and monitoring and control units. In some embodiments, the gas collection unit of the one or more flare stacks 104 may be configured to collect the excess one or more gases from various parts of a facility from the one or more facilities.

In some embodiments, the flare header of the one or more flare stacks 104 may correspond to a piping network that may be configured to transport the collected one or more gases from the gas collection unit to the one or more flare stacks 104. In some embodiments, the knockout drum of the one or more flare stacks 104 may be configured to remove any liquid constituents from the collected one or more gases to prevent liquid carryover into a flare. In some embodiments, the flare tip of the one or more flare stacks 104 may correspond to an end of the one or more flare stacks 104 when the one or more gases are ignited and burned.

In some embodiments, the pilot burner of the one or more flare stacks 104 may be configured to provide a continuous ignition source that facilitates a continuous burning of the one or more gases. In some embodiments, the steam or air injection system may be configured to provide additional oxygen or steam to the one or more flare stacks 104 during combustion of the one or more gases. In some embodiments, the flame arrestor of the one or more flare stacks 104 may be configured to prevent flashbacks of the flare generated during combustion of the one or more gases. In some embodiments, the monitoring and control units of the one or more flare stacks 104 may be configured to monitor operations of the one or more flare stacks 104 during flaring of the one or more gases.

Further, the monitoring and control units may comprise a temperature sensor, a pressure sensor, a flow rate sensor, etc. In some embodiments, a monitoring and control system may be configured to generate flare data. Further, the flare data may correspond to mass or volume of gas flared within each of the one or more flare stacks 104, temperature of the gas flared, and pressure at which the gas is flared. In one example, the flow rate sensor may be configured to detect the mass or volume of the gas flared within each of the one or more flare stacks 104, the temperature sensor may be configured to detect the temperature of the gas flared, and the pressure sensor may be configured to detect the pressure at which the gas is flared.

In some embodiments, the server 106 may correspond to a computer or software module that is configured to provide centralized resources, data, or services to the one or more flare stacks 104. The server 106 may be configured to handle and manage one or more computational tasks and data processing within the system 100. In some embodiments, the server 106 may include storage systems, such as hard drives or storage arrays, to store and manage large volumes of data and information accessible to network users. In some embodiments, the server 106 may further provide centralized control and management capabilities, allowing network administrators to configure, monitor, and maintain network resources, security settings, and user access permissions from a single location.

In some embodiments, the server 106 may be configured to receive the real-time flare data from the one or more flare stacks 104. Further, the real-time flare data may correspond to fuel composition data corresponding to a flare gas and one or more operational parameters associated with an operation of the one or more flare stacks 104. The one or more operational parameters include wind speed (U), a flare flow velocity (V), an air-assisted flow velocity (Va), a steam-assisted flow velocity (Vs), and one or more operational conditions. The one or more operational conditions include mass or volume of gas flared within each of the one or more flare stacks 104, temperature of the gas flared, and pressure at which the gas is flared. In one example, the server 106 may be communicatively coupled with the monitoring and control system (not shown) of the one or more flare stacks 104. Further, the server 106 may be configured to wirelessly receive the real-time flare data from the monitoring and control system. For example, the real-time flare data may comprise the mass or volume of gas flared within each of the one or more flare stacks 104 is 1000 cubic meters, the temperature of the gas flared is 850 degrees Celsius, and pressure at which the gas is flared is 60 psi.

In some embodiments, the server 106 may be configured to determine the optimized fuel coefficients A and B based on the real-time flare data using the AI/ML model (not shown). In some embodiments, the fuel dependent coefficients A and B are crucial to the DRE calculations and need to be dynamically optimized based on the fuel composition data, Lower Heating Values (LHVs) of the specific fuel being flared, and other factors. LHV refers to the amount of heat released when a specified amount of fuel is completely combusted. In other terms, LHV measures the usable energy that can be extracted from the specific fuel. The fuel coefficients A and B are utilized in determining the efficiency of the combustion process. Fuels with higher LHV typically provide more energy per unit mass or volume of fuel, which can lead to a higher combustion efficiency. Fuel coefficients A and B may be dynamically adjusted to account for the differences in how fuels with varying LHVs behave under flare conditions. For example, a fuel with a low LHV might require different operational settings (e.g., higher air or steam assistance) to achieve optimal combustion. For example, for Natural Gas, Fuel Coefficient A is 156.4 MJ/kg³ and Fuel Coefficient B is 0.318. However, for Propane/Ethane, Fuel Coefficient A is 32.06 MJ/kg³ and Fuel Coefficient B is 0.272. It indicates that natural gas has a higher energy content compared to propane/ethane. Fuels with higher energy content (like natural gas) typically burn more efficiently, and they may require less air or steam assistance to achieve complete combustion. Further, for different LHVs, fuel coefficients A and B might be different. For example, for Natural Gas, for LHV 41.357 MJ/kg, Fuel Coefficient A is 156.4 MJ/kg³ and Fuel Coefficient B is 0.318. For LHV 46.5819 MJ/kg, Fuel Coefficient A is 156.4 MJ/kg³ and Fuel Coefficient B is 0.318. For LHV 49.10062 MJ/kg, Fuel Coefficient A is 169 MJ/kg³ and Fuel Coefficient B is 0.279. In some embodiments, the AI/ML model may comprise a plurality of machine learning (ML) algorithms. Further, the plurality of ML algorithms may be configured to assess the flare data received at the real time to determine the optimized fuel dependent coefficients A and B per LHV.

In some embodiments, the server 106 may be configured to predict destruction and removal efficiency (DRE) per flare stack based at least on the optimized fuel coefficients A and B and the one or more operational parameters using a trained AI/ML model. DRE measures the effectiveness of the one or more flare stacks 104 in combusting or destroying gases, particularly in reducing harmful emissions. It is typically expressed as a percentage, representing the proportion of gas that is successfully burned compared to the total amount of gas sent to the flare. In some embodiments, the historical data and ground truth DRE data is collected from one or more flare stack cameras and simulated data from a first principle physics-based model. As a result, optimized fuel coefficients A and B are determined corresponding to different LHVs based on the collected historical data, the ground truth DRE data, and the simulated data and the lookup table including the optimized fuel coefficients A and B corresponding to the different LHVs is being generated. Therefore, the AI/ML model is trained based on collected historical data, the ground truth DRE data, the simulated data, and the lookup table to generate the trained AI/ML model. Air assisted flow rates and steam assisted flow rates with varying LHVs are further utilized to train the AI/ML model. The historical data includes fuel flow data, one or more operational parameters such as air-assisted flow rate, steam-assisted flow rate with varying LHVs, flare stack performance, one or more operational conditions, emission data, fuel composition data, combustion data corresponding to each of the one or more flare stacks 104. The one or more flare stacks 104 can be of different diameters or similar diameters. The AI/ML model is trained to learn patterns from the real-time flare data, the historical data, the ground truth DRE data, the simulated data, and the lookup table corresponding to the one or more flare stacks 104.

In some embodiments, the server 106 may be configured to generate one or more alerts corresponding to the predicted DRE per flare stack when the predicted DRE falls below the predetermined threshold. In some embodiments, the one or more alerts may comprise at least one of visual alerts, auditory alerts, textual alerts, tactile alerts, or remote alerts. In one example, the one or more facilities may comprise a display unit (not shown). Further, the display unit may be provided with an intrusive interface that may facilitate providing of the visual alerts to notify a user regarding the predicted DRE per flare stack. In another example, the one or more facilities may comprise an alarming unit (not shown). Further, the alarming unit may be configured to generate the auditory alerts to notify the user regarding the predicted DRE per flare stack.

In some embodiments, the server 106 may be configured to generate one or more recommendations associated with the predicted DRE in real-time. In some embodiments, the one or more recommendations may comprise at least one of change in one or more operational parameters of the one or more flare stacks 104, change in temperature of upstream vessels of the one or more flare stacks 104, or change in speed of rotating machinery of the one or more flare stacks 104. In some embodiments, the one or more recommendations may correspond to guidance for an operation of each of the one or more flare stacks 104. Further, the server 106 may be configured to determine the one or more recommendations based at least on compliance and economics of each of the one or more flare stacks 104.

In some embodiments, the server 106 may be configured to adjust the one or more operational parameters to maintain the DRE above a predetermined threshold. In one example, the server 106 may adjust at least one of the air-assisted flow velocity (Va) and the steam-assisted flow velocity (Vs) of the one or more flare stacks 104 In another example, adjustments of temperature and pressure of the one or more components associated with each of the one or more flare stacks 104. If DRE falls below the predetermined threshold, the AI/ML model may suggest varying feature values and find the appropriate feature combination of the one or more operational parameters that would improve combustion efficiency and bring DRE back to optimal levels. This proactive optimization helps ensure consistent, efficient flare operation and reduced emissions.

In some embodiments, the system 100 may comprise the user device 108. Further, the user device 108 may be communicatively coupled to the one or more flare stacks 104 through the network 102. In one example, the user device 108 may be configured to display the one or more alerts associated with the predicted DRE for the one or more flare stacks 104. In some embodiments, the user device 108 may be configured to provide a real-time insight into working and status of each component of the one or more components of the one or more flare stacks 104. Further, the user device 108 may comprise at least one of a mobile phone, tablet, laptop, etc. In some embodiments, the user device 108 may be installed with a user interface (UI) or an application programmable interface (API) that may display the one or more alerts in a readable format that may facilitate the user to take an appropriate action in response to the one or more parameter setpoints and the advisory information for the one or more flare stacks 104.

It will be apparent to one skilled in the art that above-mentioned components of the system 100 have been provided only for illustration purposes, without departing from the scope of the disclosure.

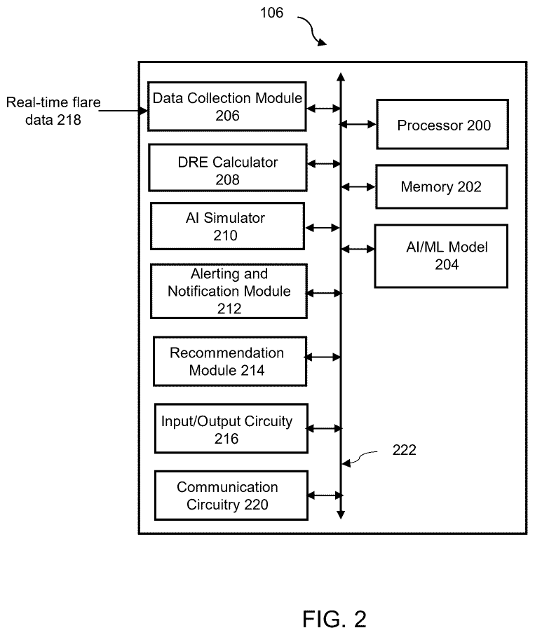

FIG. 2 illustrates a block diagram of the server 106 of the system 100, in accordance with an example embodiment of the present disclosure. FIG. 2 is described in conjunction with FIG. 1.

In some embodiments, the server 106 may comprise at least one processor 200, a memory 202, an artificial intelligence/machine learning (AI/ML) model 204, a data collection module 206, a DRE calculator 208, an AI simulator 210, an alerting and notification module 212, a recommendation module 214, an input/output circuitry 216, a communication circuitry 220, and a bus 222. In one or more example embodiments, one or more components and/or sub-systems of the system 100 may be communicatively coupled to the processor 200 and/or the memory 202 via the bus 222. In some embodiments, the at least one processor 200 may include suitable logic, circuitry, and/or interfaces that are operable to execute one or more instructions stored in the memory 202 to perform predetermined operations. In one embodiment, the at least one processor 200 may be configured to decode the one or more instructions and execute the one or more instructions that are stored within the memory 202. The at least one processor 200 may be configured to execute one or more computer-readable program instructions, such as program instructions to carry out any of the functions described in this description. Further, the at least one processor 200 may be implemented using one or more processor technologies known in the art such as central processing unit (CPU), field-programmable gate array (FPGA), digital signal processors (DSP), etc. Examples of the at least one processor 200 may comprise at least one of, one or more general purpose processors and/or one or more special purpose processors that may be designed to handle the one or more flare stacks 104.

In some embodiments, the server 106 may further comprise the data collection module 206. The data collection module 206 may be configured to receive the real-time flare data 218 from the one or more flare stacks 104. Further, the data collection module 206 may be communicatively coupled with the control and monitoring systems (not shown) of the one or more flare stacks 104 to receive the real-time flare data 218. Further, the data collection module 206 may be configured to wirelessly receive the real-time flare data 218 from the monitoring and control systems of the one or more flare stacks 104. In some embodiments, the real-time flare data 218 may include fuel composition data corresponding to a flare gas in the one or more flare stacks 104 and one or more operational parameters associated with operation of the one or more flare stacks 104. The fuel composition data may be determined using online gas chromatograph, gas sampling at regular intervals, portable gas chromatography, and drager tubes. In one example, the data collection module 206 is configured to receive the real-time flare data 218 from one or more sensors of the one or more flare stacks 104. Further, the one or more sensors may comprise a flow rate sensor, ultrasonic flowmeter, a temperature sensor, thermal mass flowmeter, a pressure sensor, and Differential Pressure Flowmeters. The one or more operational parameters include the wind speed (U), the flare flow velocity (V), the air-assisted flow velocity (Va), the steam-assisted flow velocity (Vs), and the one or more operational conditions. The one or more operational conditions include mass or volume of gas flared within each of the one or more flare stacks 104, temperature of the gas flared, and pressure at which the gas is flared. For example, the mass or volume of gas flared within each of the one or more flare stacks 104 is 1000 cubic meters, the temperature of the gas flared is 850 degrees Celsius, and pressure at which the gas is flared is 60 psi. In some embodiments, the data collection module 206 may be configured to collect historical data and the ground truth DRE data from one or more flare stack cameras and simulated data from a first principle physics-based model. The historical data includes fuel flow data, one or more operational parameters such as air-assisted flow rate, steam-assisted flow rate with varying LHVs, flare stack performance, one or more operational conditions, emission data, fuel composition data, combustion data corresponding to each of the one or more flare stacks 104. The one or more flare stacks 104 can be of different diameters or similar diameters.

In some embodiments, the at least one processor 200 may be configured to determine the optimized fuel coefficients A and B using the AI/ML model 204. In some embodiments, the AI/ML model 204 may be configured to work through a plurality of steps to cause the at least one processor 200 to determine the optimized fuel coefficients A and B for the flare gas based on the real-time flare data 218, using the AI/ML model 204. In some embodiments, the plurality of steps may include but not limited to data collection, data preprocessing, feature extraction, model training, and fuel coefficient determination. In some embodiments, during the data collection step, the data collection module 206 to receive the flare data from the one or more flare stacks 104. The flare data includes the historical data, the ground truth DRE data, the simulated data, and the real-time flare data 218. Further, the data collection module 206 may be configured to collect the flare data over a predefined period time. Further, the data collection module 206 may be configured to preprocess the flare data. Further, during the preprocessing step, the data collection module 206 may be configured to filter unwanted noise and irrelevant information from the flare data to prepare one or more datasets from the flare data. Further, during the preprocessing step, the data collection module 206 may be configured to scale the flare data into a uniform range to eliminate inconsistency from the flare data. In some embodiments, the data collection module 206 may be configured to perform the feature extraction step. Further, during the feature extraction step, the at the data collection module 206 may be configured to transform the flare data into a structured format that may be suitable for the AI/ML model 204.

In some embodiments, the at least one processor 200 may be configured to train the AI/ML model 204 using the flare data to recognize patterns. In the short term, the AI/ML model 204 such as Xgboost is trained using the ground truth DRE data obtained from one or more flare stack cameras (such as the Sensia Redlook Agni camera) and simulated data to optimize fuel coefficients A and B and accordingly, predict the DRE for one or more flare stacks 104. The ground truth DRE data for the one or more flare stacks 104 is collected to train the AI/ML model 204. Air assisted flow rates and steam assisted flow rates with varying LHVs are further utilized to train the AI/ML model 204. A combination of the camera data and the simulated data from first principle physics-based model is used to optimize fuel coefficients A and B and predict the DRE for the one or more flare stacks 104. Further, the AI/ML model 204 may analyze historical data on fuel flow and operational conditions, such as any assistance provided to the flare (like additional oxidizers or adjustments in operation). The historical data includes the amount of fuel that is sent to the flare, flare stack performance, and environmental conditions. Computer vision techniques are used to analyze images from the flare stack, assessing factors like flame characteristics and combustion quality. For different fuel compositions, the values of fuel coefficients A and B are different. Also, for different Lower Heating Values (LHVs), there are different fuel coefficients A and B. These fuel coefficients A and B are the optimized fuel coefficients for the respective LHVs. In the long term, once enough data has been gathered for various flare stacks having different diameters, the AI/ML model 204 is trained for each individual flare stack based on unique parameters (diameter, windspeed, flare flow velocity, air-assisted flow velocity, steam-assisted flow velocity, environmental conditions) to predict the DRE using optimized fuel coefficients A and B and a universal AI/ML model 204 could be developed. This AI/ML model 204 will be applicable across different flare stacks without the need for constant camera data, as it will learn patterns based on the historical data, including operational variables like fuel flow, wind speed, flare stack diameter, and assistance factors (air and steam). A lookup table could be created for different values of fuel coefficients A and B corresponding to different LHVs. This AI/ML model 204 will adjust the DRE predictions dynamically based on real-time data from ongoing operations, enabling continuous optimization without manual input. This approach allows for real-time DRE calculation based on ongoing data, eliminating the need for expensive hardware in the long term.

In some embodiments, the at least one processor 200 may be configured to determine the optimized fuel coefficients A and B for the specific fuel based on the real-time flare data 218, using the AI/ML model 204. In some embodiments, the at least one processor 200 may be configured to involve one or more ML algorithms to train the AI/ML model 204 to determine the fuel coefficients A and B. Further, the one or more ML algorithms may include but not limited to linear regression, decision trees, random forest, support vector machines (SVMs), neural networks, and gradient boosting machines (GBM). In some embodiments, the training process of the AI/ML model 204 involve selection of an appropriate ML algorithm. In some embodiments, upon selecting the appropriate AI/ML model 204, the at least one processor 200 may be configured to split the one or more datasets “i.e. the flare data” into a training dataset and a testing dataset. Further, the training dataset may be utilized to train the AI/ML model 204, and the testing dataset may be utilized to test the trained AI/ML model 204.

In some embodiments, the trained AI/ML model 204 may cause the at least one processor 200 to determine the fuel coefficients A and B by analyzing the real-time flare data 218. Further, the AI/ML model 204 may cause the at least one processor 200 to monitor the real-time flare data 218 and compare the real-time flare data 218 with a learned pattern of the flare data using the appropriate ML algorithm to optimize the fuel coefficients A and B for the specific flare gas.

In some embodiments, the server 106 may further comprise the DRE calculator 208. The DRE calculator 208 may be configured to predict destruction and removal efficiency (DRE) per flare stack based at least on the optimized fuel coefficients A and B and the one or more operational parameters using the trained AI/ML model 204 (as described in detail above). DRE measures the effectiveness of the one or more flare stacks 104 in combusting or destroying gases, particularly in reducing harmful emissions. It is typically expressed as a percentage, representing the proportion of gas that is successfully burned compared to the total amount of gas sent to the flare. Further, the at least one processor 200 may utilize the AI/ML model 204 to predict the DRE for the one or more flare stacks 104.

DRE=MLFunc (A, B, LHV, U, V, Va, Vs, d),
where A, B, and LHV are fuel coefficients, U is windspeed, V is flare flow velocity, Va is air-assisted flow velocity, Vs is steam-assisted flow velocity, and d is flare stack diameter.

In some embodiments, the at least one processor 200 may be configured to train the AI/ML model 204 using the previously recorded flare data. Further, during the training phase of the AI/ML model 204, the ML model 204 may cause the at least one processor 200 to learn to recognize one or more patterns and correlation with the previously recorded flare data. Further, the AI/ML model 204 may cause the at least one processor 200 to adjust its internal parameters to minimize prediction errors during the training phase. In some embodiments, once the AI/ML model 204 is trained, the at least one processor 200 may predict the DRE by correlating the real-time flare data 218 with one or more patterns learned by the trained AI/ML model 204.

In some embodiments, the server 106 may further comprise the alerting and notification module 212. The alerting and notification module 212 may be configured to generate one or more alerts corresponding to the predicted DRE per flare stack when the predicted DRE falls below a predetermined threshold. In some embodiments, the one or more alerts may comprise at least one of visual alerts, auditory alerts, textual alerts, tactile alerts, or remote alerts. In one example, the one or more facilities may comprise a display unit (not shown). Further, the display unit may be provided with an intrusive interface that may facilitate providing of the visual alerts to notify a user regarding the predicted DRE per flare stack. In another example, the one or more facilities may comprise an alarming unit (not shown). Further, the alarming unit may be configured to generate the auditory alerts to notify the user regarding the predicted DRE per flare stack.

In some embodiments, the server 106 may further comprise the recommendation module 214. The recommendation module 214 may be configured to generate one or more recommendations associated with the predicted DRE in real-time. In some embodiments, the one or more recommendations may comprise at least one of change in one or more operational parameters of the one or more flare stacks 104, change in temperature of upstream vessels of the one or more flare stacks 104, or change in speed of rotating machinery of the one or more flare stacks 104. In some embodiments, the one or more recommendations may correspond to guidance for an operation of each of the one or more flare stacks 104. Further, the recommendation module 214 may be configured to determine the one or more recommendations based at least on compliance and economics of each of the one or more flare stacks 104.

In some embodiments, the at least one processor 204 may cause the AI/ML model 204 to adjust the one or more operational parameters to maintain the DRE above the predetermined threshold. In one example, the server 106 may adjust at least one of the air-assisted flow velocity (Va) and the steam-assisted flow velocity (Vs) of the one or more flare stacks 104 In another example, adjustments of temperature and pressure of the one or more components associated with each of the one or more flare stacks 104. If DRE falls below the predetermined threshold, the AI simulator 210 may vary feature values and find the appropriate feature combination of the one or more operational parameters that would improve combustion efficiency and bring DRE back to optimal levels. This proactive optimization helps ensure consistent, efficient flare operation and reduced emissions.

In some embodiments, the memory 202 may be configured to store a set of instructions and data executed by the at least one processor 200. Further, the memory 202 may include the one or more instructions that are executable by the at least one processor 200 to perform specific operations. The memory 202 may be configured to include the instructions to receive the real-time flare data 218 from the one or more flare stacks 104 in real time. The memory 202 may be configured to include the instructions to determine the optimized fuel coefficients A and B, using the trained AI/ML model 204. Further, the memory 202 may be configured to include the instructions to predict the Destruction and Removal Efficiency (DRE) corresponding to the at least one flare stack, based at least on the fuel coefficients A and B and the one or more operational parameters, using the trained AI/ML model 204. The memory 202 may be configured to include the instructions to generate real-time recommendations to adjust the one or more operational parameters to maintain the DRE above the predetermined threshold, using the AI/ML model 204. Further, the memory 202 may be configured to include the instructions to generate one or more alerts when the DRE falls below the predetermined threshold.

The memory 202 may be configured to store the flare data of the one or more components of the one or more flare stacks 104. It is apparent to a person with ordinary skill in the art that the one or more instructions stored in the memory 202 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

In some embodiments, the server 106 may further comprise the input/output circuity 216. The input/output circuitry 216 may enable the user to communicate or interface with the system 100, via the user device 108. The user device 108 may include N number of user devices. In some embodiments, the input/output circuitry 216 may act as a medium to transmit input from the one or more flare stacks 104 to and from the system 100. In some embodiments, the input/output circuitry 216 may refer to the hardware and software components that facilitate the exchange of information between the user device 108 and the server 106. In one example, the server 106 may include the user interface as input circuitry that facilitates monitoring of the data of the one or more components of the one or more flare stacks 104. The input/output circuitry 216 may include various input devices such as the one or more components of the one or more flare stacks 104 and various output devices such as the user device 108, printers for the one or more users to receive data.

In some embodiments, the server 106 may further comprise the communication circuitry 220. The communication circuitry 220 may allow the server 106 to exchange data or information with the user device 108, other systems or apparatuses. Further, the communication circuitry 220 may include network interfaces, protocols, and software modules responsible for sending and receiving data or information from the user device 108. In some embodiments, the communication circuitry 220 may include Ethernet ports, Wi-Fi adapters, or communication protocols like HTTP or MQTT for connecting with other systems. The communication circuitry 220 may further include components such as communication modules (e.g., Wi-Fi, Ethernet, cellular), transceivers, antennas, and protocols (e.g., TCP/IP, MQTT, SNMP) for exchanging data with the user device 108 and the other systems. The communication circuitry 220 may allow the server 106 to stay up-to-date.

It will be apparent to one skilled in the art the above-mentioned components of the server 106 have been provided only for illustration purposes, without departing from the scope of the disclosure.

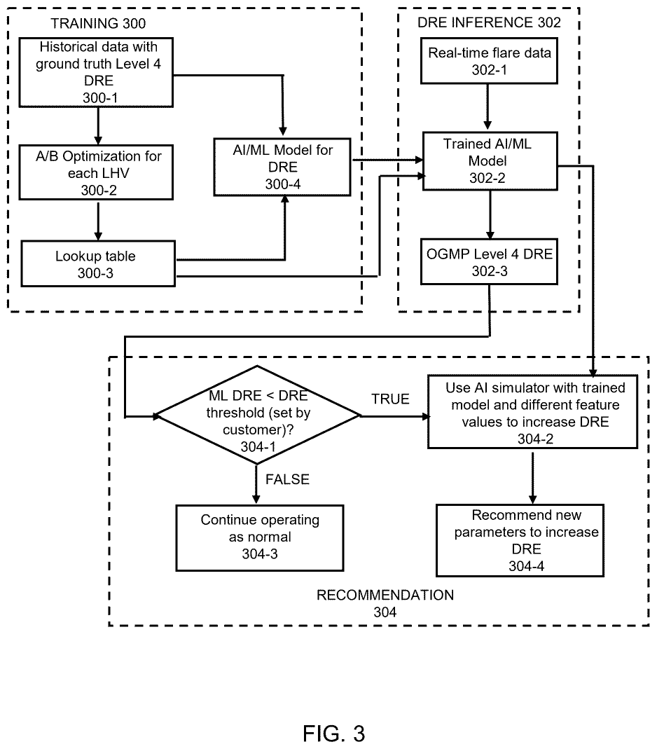

FIG. 3 illustrates a block diagram showing different stages of the system 100 for managing the flare efficiency reporting for the one or more flare stacks 104 in accordance with an example embodiment of the present disclosure.

At training stage 300, at step 300-1, the data collection module 206 may be configured to collect historical data and the ground truth DRE data from one or more flare stack cameras. Further, the data collection module 206 is configured to collect simulated data from a first principle physics-based model. The historical data includes fuel flow data, one or more operational parameters such as air-assisted flow rate, steam-assisted flow rate with varying LHVs, flare stack performance, one or more operational conditions, emission data, fuel composition data, combustion data corresponding to each of the one or more flare stacks 104. The one or more flare stacks 104 may be of different diameters or similar diameters.

At step 300-2, the at least one processor 200 may be configured to determine the optimized fuel coefficients A and B for different LHVs for different fuels based on the data collected at step 300-1. The fuel dependent coefficients A, B, and LHV are crucial to the DRE predictions and need to be dynamically optimized. The fuel coefficients A and B are utilized in determining the efficiency of the combustion process. Fuels with higher LHV typically provide more energy per unit mass or volume of fuel, which can lead to a higher combustion efficiency. Fuel coefficients A and B may be dynamically adjusted to account for the differences in how fuels with varying LHVs behave under flare conditions. For example, a fuel with a low LHV might require different operational settings (e.g., higher air or steam assistance) to achieve optimal combustion. For example, for Natural Gas, Fuel Coefficient A is 156.4 MJ/kg³ and Fuel Coefficient B is 0.318. However, for Propane/Ethane, Fuel Coefficient A is 32.06 MJ/kg³ and Fuel Coefficient B is 0.272. It indicates that natural gas has a higher energy content compared to propane/ethane. Fuels with higher energy content (like natural gas) typically burn more efficiently, and they may require less air or steam assistance to achieve complete combustion. Further, for different LHVs, fuel coefficients A and B might be different.

At step 300-3, the at least one processor 200 may be configured to generate a lookup table based on the data collected at steps 300-1 and 300-2. The lookup table includes fuel coefficients A and B corresponding to different LHVs. For example, for Natural Gas, for LHV 41.357 MJ/kg, Fuel Coefficient A is 156.4 MJ/kg³ and Fuel Coefficient B is 0.318. For LHV 46.5819 MJ/kg, Fuel Coefficient A is 156.4 MJ/kg³ and Fuel Coefficient B is 0.318. For LHV 49.10062 MJ/kg, Fuel Coefficient A is 169 MJ/kg³ and Fuel Coefficient B is 0.279.

At step 300-4, the at least one processor 200 may be configured to input data collected at step 300-1 and 300-3 into the AI/ML model 204. Accordingly, in the short term, the AI/ML model 204 such as Xgboost is trained using the historical data and the ground truth DRE data obtained from one or more flare stack cameras (such as the Sensia Redlook Agni camera) and the simulated data. The lookup table created at step 300-3 is also utilized to train the AI/ML model 204. Air assisted flow rates and steam assisted flow rates with varying LHVs are further utilized to train the AI/ML model. Further, the AI/ML model 204 may analyze historical data on fuel flow and operational conditions, such as any assistance provided to the flare (like additional oxidizers or adjustments in operation). The historical data includes the amount of fuel that is sent to the flare, flare stack performance, and environmental conditions. Computer vision techniques are used to analyze images from the flare stack, assessing factors like flame characteristics and combustion quality. In the long term, once enough data has been gathered for various flare stacks having different diameters, the AI/ML model 204 is trained for each individual flare stack based on unique parameters (diameter, windspeed, flare flow velocity, air-assisted flow velocity, steam-assisted flow velocity, environmental conditions) and a universal AI/ML model 204 could be developed. This model will be applicable across different flare stacks without the need for constant camera data, as it will learn patterns based on the historical data, including operational variables like fuel flow, wind speed, flare stack diameter, and assistance factors (air and steam).

At DRE inference stage 302, at step 302-1, the at least one processor 200 may be configured to determine operational visibility of the one or more flare stacks 104. In one example, the at least one processor 200 may be configured to determine the operational visibility of the one or more flare stacks 104 using one or more sensors such as temperature sensor, pressure sensor, and flow rate sensor. In some embodiments, the at least one processor 200 may be configured to receive the real-time flare data 218 from the one or more flare stacks 104, upon determining the operational visibility of the one or more flare stacks 104. In some embodiments, the at least one processor 200 may be configured to determine operational visibility of the one or more flare stacks 104, based at least on the real-time flare data 218. In some embodiments, the flare data may correspond to a flaring induced emission calculation and visualization of the one or more flare stacks 104. In some embodiments, the flare data may be detected by the monitoring and control system of the one or more flare stacks 104. Further, the monitoring and control units may comprise a temperature sensor, a pressure sensor, a flow rate sensor, etc. In some embodiments, the monitoring and control system may be configured to generate the real-time flare data 218. Further, the real-time flare data 218 may correspond to fuel composition data corresponding to the flare gas and the one or more operational parameters associated with the operation of the one or more flare stacks 104. The one or more operational parameters include wind speed (U), flare flow velocity (V), air-assisted flow velocity (Va), steam-assisted flow velocity (Vs), and the one or more operational conditions. The one or more operational conditions include mass or volume of gas flared within each of the one or more flare stacks 104, temperature of the gas flared, and pressure at which the gas is flared.

At step 302-2, the at least one processor 200 may be configured to determine the optimized fuel coefficients A and B based on the real-time flare data 218, using the trained AI/ML model 204. In some embodiments, the fuel dependent coefficients A and B are crucial to the DRE calculations and need to be dynamically optimized based on the fuel composition data, Lower Heating Values (LHVs) of the specific fuel being flared, and other factors. Further, the at least one processor 200 may be configured to monitor the real-time flare data 218 and compare the real-time flare data 218 with a learned pattern of the flare data using the appropriate ML algorithm to optimize the fuel coefficients A and B for the specific flare gas. In some embodiments, the AI/ML model 204 may comprise the plurality of machine learning (ML) algorithms. Further, the plurality of ML algorithms of the AI/ML model 204 may cause the at least one processor 200 to assess the real-time flare data 218 to determine the optimized fuel coefficients A and B.

At step 302-3, the at least one processor 200 may be configured to predict destruction and removal efficiency (DRE) per flare stack based at least on the optimized fuel coefficients A and B and the one or more operational parameters using the trained AI/ML model 204 (as described in detail above). DRE measures the effectiveness of the one or more flare stacks 104 in combusting or destroying gases, particularly in reducing harmful emissions. It is typically expressed as a percentage, representing the proportion of gas that is successfully burned compared to the total amount of gas sent to the flare. Further, the at least one processor 200 may utilize the AI/ML model 204 to predict the DRE for the one or more flare stacks 104.

DRE=MLFunc (A, B, LHV, U, V, Va, Vs, d),
where A, B, and LHV are fuel coefficients, U is windspeed, V is flare flow velocity, Va is air-assisted flow velocity, Vs is steam-assisted flow velocity, and d is flare stack diameter.

At recommendation stage 304, at step 304-1, the at least one processor 200 may be configured to determine whether the predicted DRE falls below the predetermined threshold. The predetermined threshold could be set by the user. If DRE falls below the predetermined threshold, at step 304-2, the AI simulator 210 may vary feature values and find the appropriate feature combination that would improve combustion efficiency and bring the DRE back to optimal levels. In one example, the predetermined threshold could be 98%. At step 304-4, consider a scenario where a flare stack experiences a drop in DRE below the predetermined threshold, the AI/ML model 204 might recommend adjusting steam flow to 400 kg/h and air flow to 500 kg/h based on the historical data and real-time feedback. As a result, DRE increases, bringing it back to an optimal range. Further, if it is determined that the predicted DRE is equal or above the predetermined threshold at step 304-1, then the system 102 at step 304-3 would continue to operate as normal. This proactive optimization helps ensure consistent, efficient flare operation and reduced emissions.

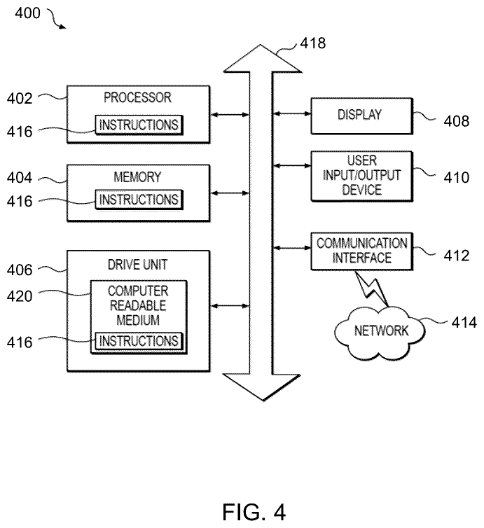

FIG. 4 illustrates a schematic diagram showing an implementation of a controller that may execute techniques in accordance with one or more example embodiments described herein. The controller 400 may include a set of instructions that may be executed to cause the controller 400 to perform any one or more of the methods or computer-based functions disclosed herein. The controller 400 may operate as a standalone device or may be connected, e.g., using a network, to other computer systems or peripheral devices.

In a networked deployment, the controller 400 may operate in the capacity of a server or as a client in a server-client user network environment, or as a peer computer system in a peer-to-peer (or distributed) network environment. The controller 400 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the controller 400 may be implemented using electronic devices that provide voice, video, or data communication. Further, while the controller 400 is illustrated as a single system, the term “system” shall also be taken to include any collection of systems or sub-systems that individually or jointly execute a set, or multiple sets, of instructions to perform one or more computer functions.

As illustrated in FIG. 4, the controller 400 may include a processor 402, e.g., a central processing unit (CPU), a graphics processing unit (GPU), or both. The processor 402 may be a component in a variety of systems. For example, the processor 402 may be part of a standard computer. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The controller 400 may include a memory 404 that may communicate via a bus 418. The memory 404 may be a main memory, a static memory, or a dynamic memory. The memory 404 includes, but may not be limited to, computer readable storage media such as various types of volatile and non-volatile storage media, including but may not be limited to, random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of the processor 402, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the controller 400 may further include a display 408, such as a liquid crystal display (LCD), an organic light emitting diode (OLED), a flat panel display, a solid-state display, a cathode ray tube (CRT), a projector, a printer or other now known or later developed display device for outputting determined information. The display 348 may act as an interface for the user to see the functioning of the processor 402, or specifically as an interface with the software stored in the memory 404 or in the drive unit 406.

Additionally or alternatively, the controller 400 may include an input/output device 410 configured to allow a user to interact with any of the components of controller 400. The input/output device 410 may be a number pad, a keyboard, or a cursor control device, such as a mouse, or a joystick, touch screen display, remote control, or any other device operative to interact with the controller 400.

The controller 400 may also or alternatively include drive unit 406 implemented as a disk or optical drive. The drive unit 406 may include a computer-readable medium 420 in which one or more sets of instructions 416, e.g. software, may be embedded. Further, the instructions 416 may embody one or more of the methods or logic as described herein. The instructions 416 may reside completely or partially within the memory 404 and/or within the processor 402 during execution by the controller 400. The memory 404 and the processor 402 also may include computer-readable media as discussed above.

In some systems, a computer-readable medium 420 includes instructions 416 or receives and executes instructions 416 responsive to a propagated signal so that a device connected to a network 414 may communicate voice, video, audio, images, or any other data over the network 414. Further, the instructions 416 may be transmitted or received over the network 414 via a communication port or interface 412, and/or using the bus 418. The communication port or interface 412 may be a part of the processor 402 or may be a separate component. The communication port or interface 412 may be created in software or may be a physical connection in hardware. The communication port or interface 412 may be configured to connect with a network 414, external media, the display 408, or any other components in controller 400, or combinations thereof. The connection with the network 414 may be a physical connection, such as a wired Ethernet connection or may be established wirelessly as discussed below. Likewise, the additional connections with other components of the controller 400 may be physical connections or may be established wirelessly. The network 414 may alternatively be directly connected to the bus 418.

While the computer-readable medium 420 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by the processor 402 or that cause a computer system to perform any one or more of the methods or operations disclosed herein. The computer-readable medium 420 may be non-transitory, and may be tangible.

The computer-readable medium 420 may include a solid-state memory such as a memory card or other package that houses one or more non-volatile read-only memories. The computer-readable medium 420 may be a random-access memory or other volatile re-writable memory. Additionally or alternatively, the computer-readable medium 420 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, may be constructed to implement one or more of the methods described herein. Applications that may include the apparatus and systems of various implementations may broadly include a variety of electronic and computer systems. One or more implementations described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

The controller 400 may be connected to a network 414. The network 414 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but may not be limited to, TCP/IP based networking protocols. The network 414 may include wide area networks (WAN), such as the Internet, local area networks (LAN), campus area networks, metropolitan area networks, a direct connection such as through a Universal Serial Bus (USB) port, or any other networks that may allow for data communication. The network 414 may be configured to couple one computing device to another computing device to enable communication of data between the devices. The network 414 may generally be enabled to employ any form of machine-readable media for communicating information from one device to another. The network 414 may include communication methods by which information may travel between computing devices. The network 414 may be divided into sub-networks. The sub-networks may allow access to all of the other components connected thereto or the sub-networks may restrict access between the components. The network 414 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations may include distributed processing, component/object distributed processing, and parallel processing. Alternatively, virtual computer system processing may be constructed to implement one or more of the methods or functionalities as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

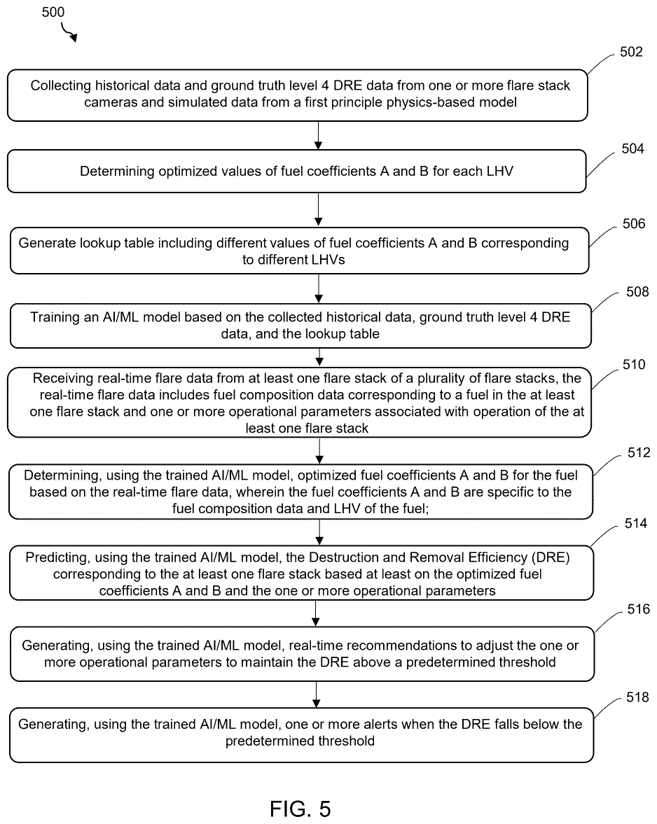

FIG. 5 illustrates a detailed flowchart showing a method 500 for managing the flare efficiency reporting for the one or more flare stacks 104 using the AI/ML model 204, in accordance with an example embodiment of the present disclosure.

At operation 502, the data collection module 206 may be configured to collect historical data and ground truth level 4 DRE data from one or more flare stack cameras. Further, the data collection module 206 is configured to collect simulated data from a first principle physics-based model. The historical data includes fuel flow data, one or more operational parameters such as air-assisted flow rate, steam-assisted flow rate with varying LHVs, flare stack performance, one or more operational conditions, emission data, fuel composition data, combustion data corresponding to the one or more flare stacks 104.

At operation 504, the at least one processor 200 may be configured to determine the optimized fuel coefficients A and B for different LHVs for different fuels based on the collected historical data, the ground truth level 4 DRE data, and the simulated data. The fuel dependent coefficients A, B, and LHV are crucial to the DRE predictions and need to be dynamically optimized. The fuel coefficients A and B are utilized in determining the efficiency of the combustion process.

At operation 506, the at least one processor 200 may be configured to generate a lookup table based on the collected historical data, the ground truth level 4 DRE data, the simulated data, and the optimized fuel coefficients. The lookup table includes fuel coefficients A and B corresponding to different LHVs.

At operation 508, the AI/ML model 204 is trained using the historical data and the ground truth level 4 DRE data obtained from one or more flare stack cameras (such as the Sensia Redlook Agni camera) and the simulated data. The lookup table is also utilized to train the AI/ML model 204. Air assisted flow rates and steam assisted flow rates with varying LHVs are further utilized to train the AI/ML model 204. Further, the AI/ML model 204 may analyze the historical data on fuel flow and operational conditions, such as any assistance provided to the flare (like additional oxidizers or adjustments in operation). The historical data includes the amount of fuel that is sent to the flare, flare stack performance, and environmental conditions. Computer vision techniques are used to analyze images from the flare stack, assessing factors like flame characteristics and combustion quality. In the long term, once enough data has been gathered for various flare stacks having different diameters, the AI/ML model 204 is trained for each individual flare stack based on unique parameters (diameter, windspeed, flare flow velocity, air-assisted flow velocity, steam-assisted flow velocity, environmental conditions) and a universal AI/ML model 204 could be developed. This model will be applicable across different flare stacks without the need for constant camera data, as it will learn patterns based on the historical data, including operational variables like fuel flow, wind speed, flare stack diameter, and assistance factors (air and steam).

At operation 510, the at least one processor 200 may be configured to receive the flare data from the one or more flare stacks 104 in real time from the one or more flare stacks 104. The real-time flare data 218 may correspond to fuel composition data corresponding to the flare gas and the one or more operational parameters associated with the operation of the one or more flare stacks 104. The one or more operational parameters include wind speed (U), flare flow velocity (V), air-assisted flow velocity (Va), steam-assisted flow velocity (Vs), and the one or more operational conditions. The one or more operational conditions include mass or volume of gas flared within each of the one or more flare stacks 104, temperature of the gas flared, and pressure at which the gas is flared. For example, the real-time flare data 218 may comprise the mass or volume of gas flared within each of the one or more flare stacks 104 is 1200 cubic meters, the temperature of the gas flared is 600 degrees Celsius, and pressure at which the gas is flared is 40 psi. For example, in a large oil refinery, one or more flare stacks 104 having a network of one or more components such as burners, ignition system, sensors, and control units. Further, at least one processor 200 associated with the system 100 is configured to receive the flare data from a flare stack in real time.

At operation 512, the at least one processor 200 may be configured to determine the optimized fuel coefficients A and B based on the real-time flare data 218 using the trained AI/ML model 204. In some embodiments, the fuel dependent coefficients A and B are crucial to the DRE calculations and need to be dynamically optimized based on the fuel composition data, Lower Heating Values (LHVs) of the specific fuel being flared, and other factors. Further, the at least one processor 200 may be configured to monitor the real-time flare data 218 and compare the real-time flare data 218 with a learned pattern of the flare data using the appropriate ML algorithm to optimize the fuel coefficients A and B for the specific flare gas. In some embodiments, the AI/ML model 204 may comprise the plurality of machine learning (ML) algorithms. Further, the plurality of ML algorithms of the AI/ML model 204 may cause the at least one processor 200 to assess the real-time flare data 218 to determine the optimized fuel coefficients A and B.

At operation 514, the at least one processor 200 may be configured to predict destruction and removal efficiency (DRE) per flare stack based at least on the optimized fuel coefficients A and B and the one or more operational parameters, using the trained AI/ML model 204 (as described in detail above). DRE measures the effectiveness of the one or more flare stacks 104 in combusting or destroying gases, particularly in reducing harmful emissions. It is typically expressed as a percentage, representing the proportion of gas that is successfully burned compared to the total amount of gas sent to the flare. Further, the at least one processor 200 may utilize the AI/ML model 204 to predict the DRE for the one or more flare stacks 104.

DRE=MLFunc (A, B, LHV, U, V, Va, Vs, d), where A, B, and LHV are fuel coefficients, U is windspeed, V is flare flow velocity, Va is air-assisted flow velocity, Vs is steam-assisted flow velocity, and d is flare stack diameter.

At operation 516, the at least one processor 200 may be configured to determine whether the predicted DRE falls below the predetermined threshold. The predetermined threshold could be set by the user. If DRE falls below the predetermined threshold, the AI simulator 210 may vary feature values and find the appropriate feature combination that would improve combustion efficiency and bring the DRE back to optimal levels. As a result, DRE increases, bringing it back to an optimal range.

At operation 518, the at least one processor 200 may be configured to generate one or more alerts corresponding to the predicted DRE per flare stack when the predicted DRE falls below the predetermined threshold. In some embodiments, the one or more alerts may comprise at least one of visual alerts, auditory alerts, textual alerts, tactile alerts, or remote alerts.

The present disclosure streamlines the process of flaring by the one or more flare stacks 104. Embodiments of the present invention may ensure a precise analysis of the flare data using the AI/ML model 204. Embodiments of the present invention may determine the optimized fuel coefficients A and B using the AI/ML model 204. Embodiments of the present invention predict the DRE corresponding to the flare stack based on the optimized fuel coefficients A and B and the one or more operational parameters. Embodiments of the present invention may improve accuracy of the system 100 to predict the DRE for the one or more flare stacks 104. Embodiments of the present invention may alert the user about the one or more thresholds corresponding to the predicted DRE.

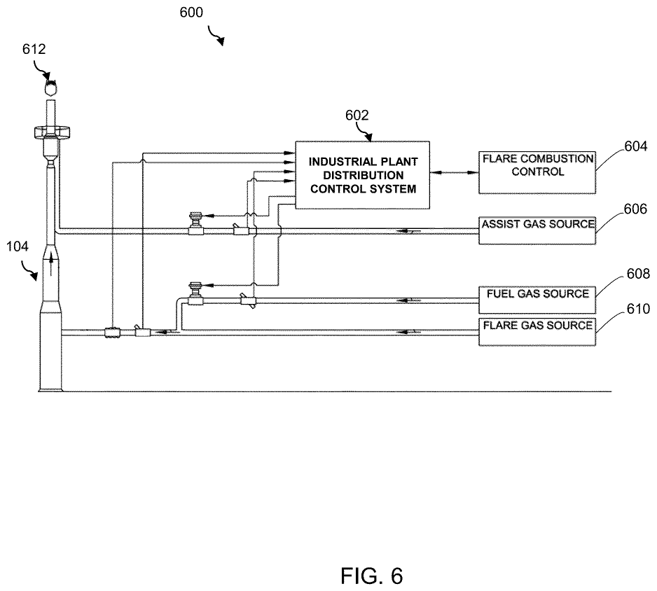

FIG. 6 illustrates an exemplary scenario of an industrial setting 600 having one or more flare stacks 104, in accordance with an example embodiment of the present disclosure. FIG. 6 is described in conjunction with FIGS. 1-5.

In some embodiments, the industrial setting 600 may comprise the one or more flare stacks 104, the industrial plant distribution control system 602, a flare combustion control 604, an assist gas source 606, a fuel gas source 608, and a flare gas source 610. In some embodiments, the one or more flare stacks 104 are vertical pipes that may be configured to release and combust the excess gases. Further, a flame 612 on a top end of the one or more flare stacks 104 may indicate combustion of the gases. In some embodiments, the industrial plant distribution control system 602 may be configured to manage distribution of gases within the industrial setting 600. In some embodiments, the industrial plant distribution control system 602 may be configured to interface with the flare combustion control 604 to regulate the flaring based on real-time data. In some embodiments, the flare combustion control 604 may be configured to monitor and regulate a combustion process in the one or more flare stacks 104. Further, the flare combustion control 604 may be configured to adjust the one or more parameters such as flame stability, combustion temperature, and gas flow rates to ensure efficient and safe burning of gases.

In some embodiments, the assist gas source 606 may be configured to provide auxiliary gases (such as steam, air, or nitrogen) to enhance the flaring process. Further, the assist gases may help to achieve complete combustion, reducing smoke and emissions. In some embodiments, the fuel gas source 608 may be configured to supply a fuel gas to maintain a continuous pilot flame, ensuring the flare is always ready to ignite any flared gases. Further, the flare gas source 610 may be configured to supply the excess gases that need to be flared, originating from various process units within the industrial setting 600 (e.g., relief valves, blowdown systems, or emergency venting systems).

In one example, the excess gases may be directed from the flare gas source 610 into the one or more flares for combustion. Further, the flow rate and volume of the supplied gases may be managed by the industrial plant distribution control system 602. Further, the assist gases may be supplied into the one or more flare stacks 104 to support the combustion process. Further, the flow rate of assist gases may be controlled to ensure optimal mixing and efficient burning of the flare gases. Further, a continuous supply of fuel gas may be maintained to keep the pilot flame active. Further, the fuel gas may be configured to ensure that any incoming flare gases may be immediately ignited, preventing the release of unburned gases. Further, the flare combustion control 604, in conjunction with the industrial plant distribution control system 602, may be configured to monitor and adjust the entire process of the flaring.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system, comprising:
a memory; and
at least one processor communicatively coupled to the memory, wherein the at least one processor is configured to:
receive real-time flare data from at least one flare stack of a plurality of flare stacks, wherein the real-time flare data includes fuel composition data corresponding to a flare gas in the at least one flare stack and one or more operational parameters associated with operation of the at least one flare stack;
determine, using a trained Artificial Intelligence/Machine Learning (AI/ML) model, fuel coefficients A and B for the flare gas based on the real-time flare data, wherein the fuel coefficients A and B are specific to the fuel composition data and a lower heating value (LHV) of the flare gas;
predict, using the trained AI/ML model, a Destruction and Removal Efficiency (DRE) corresponding to the at least one flare stack based at least on the fuel coefficients A and B and the one or more operational parameters; and
generate, using the trained AI/ML model, real-time recommendations to maintain the DRE above a predetermined threshold when the predicted DRE falls below the predetermined threshold.

2. The system of claim 1, wherein
the one or more operational parameters include at least one of wind speed (U), a flare flow velocity (V), an air-assisted flow velocity (Va), a steam-assisted flow velocity (Vs), a flare stack diameter (d), and one or more operational conditions, and
the one or more operational conditions include at least one of mass or volume of the flare gas within each of the plurality of flare stacks, temperature of the flare gas, and pressure at which the flare gas is flared.

3. The system of claim 1, wherein the at least one processor is further configured to:
collect historical data and ground truth DRE data from one or more flare stack cameras and simulated data from a first principle physics-based model;
determine optimized fuel coefficients A and B corresponding to different LHVs based on the collected historical data, the ground truth DRE data, and the simulated data;
generate lookup table including the optimized fuel coefficients A and B corresponding to the different LHVs; and
train an AI/ML model based on the collected historical data, the ground truth DRE data, the simulated data, and the lookup table to generate the trained AI/ML model.

4. The system of claim 3, wherein the historical data corresponding to the plurality of flare stacks includes at least one of fuel flow data, one or more operational parameters, flare stack performance, one or more operational conditions, emission data, the fuel composition data, combustion data corresponding to each of the plurality of flare stacks.

5. The system of claim 3, wherein the AI/ML model is trained to learn patterns from the real-time flare data, the historical data, the ground truth DRE data, the simulated data, and the lookup table corresponding to the plurality of flare stacks.

6. The system of claim 1, wherein the at least one processor is configured to generate one or more alerts when the DRE falls below the predetermined threshold.

7. The system of claim 2, wherein the DRE is a function of the fuel coefficients A and B, the lower heating value (LHV), the wind speed (U), the flare flow velocity (V), the air-assisted flow velocity (Va), the steam-assisted flow velocity (Vs), and the flare stack diameter (d).

8. The system of claim 1, wherein the at least one processor is configured to:
determine whether the predicted DRE falls below the predetermined threshold; and
adjust, using the trained AI/ML model, the one or more operational parameters to increase the DRE above the predetermined threshold.

9. The system of claim 8, wherein an air-assisted flow velocity (Va) and a steam-assisted flow velocity (Vs) are adjusted to increase the DRE above the predetermined threshold.

10. The system of claim 1, wherein the at least one flare stack of the plurality of flare stacks includes one or more sensors to collect the real-time flare data.

11. A method, comprising:
receiving real-time flare data from at least one flare stack of a plurality of flare stacks, wherein the real-time flare data includes fuel composition data corresponding to a flare gas in the at least one flare stack and one or more operational parameters associated with operation of the at least one flare stack;
determining, using a trained Artificial Intelligence/Machine Learning (AI/ML) model, fuel coefficients A and B for the flare gas based on the real-time flare data, wherein the fuel coefficients A and B are specific to the fuel composition data and a lower heating value (LHV) of the flare gas;
predicting, using the trained AI/ML model, a Destruction and Removal Efficiency (DRE) corresponding to the at least one flare stack based at least on the fuel coefficients A and B and the one or more operational parameters; and
generating, using the trained AI/ML model, real-time recommendations to maintain the DRE above a predetermined threshold when the predicted DRE falls below the predetermined threshold.

12. The method of claim 11, further comprising:
collecting historical data and ground truth DRE data from one or more flare stack cameras and simulated data from a first principle physics-based model;
determining optimized fuel coefficients A and B corresponding to different LHVs based on the collected historical data, the ground truth DRE data, and the simulated data; and
generating lookup table including the optimized fuel coefficients A and B corresponding to the different LHVs; and
training an AI/ML model based on the collected historical data, the ground truth DRE data, the simulated data, and the lookup table to generate the trained AI/ML model.

13. The method of claim 12, wherein the AI/ML model is trained to learn patterns from the real-time flare data, the historical data, the ground truth DRE data, the simulated data, and the lookup table corresponding to the plurality of flare stacks.

14. The method of claim 11, further comprising generating one or more alerts when the DRE falls below the predetermined threshold.

15. The method of claim 11, further comprising:
determining whether the predicted DRE falls below the predetermined threshold; and
adjusting, using the trained AI/ML model, the one or more operational parameters to increase the DRE above the predetermined threshold.

16. A non-transitory machine-readable information storage medium comprising one or more instructions which when executed by at least one processor cause the at least one processor to:
receive real-time flare data from at least one flare stack of a plurality of flare stacks, wherein the real-time flare data includes fuel composition data corresponding to a flare gas in the at least one flare stack and one or more operational parameters associated with operation of the at least one flare stack;
determine, using a trained Artificial Intelligence/Machine Learning (AI/ML) model, fuel coefficients A and B for the flare gas based on the real-time flare data, wherein the fuel coefficients A and B are specific to the fuel composition data and a lower heating value (LHV) of the flare gas;
predict, using the trained AI/ML model, a Destruction and Removal Efficiency (DRE) corresponding to the at least one flare stack based at least on the fuel coefficients A and B and the one or more operational parameters; and
generate, using the trained AI/ML model, real-time recommendations to maintain the DRE above a predetermined threshold when the predicted DRE falls below the predetermined threshold.

17. The non-transitory machine-readable information storage medium of claim 16, wherein the at least one processor is configured to:
collect historical data and ground truth DRE data from one or more flare stack cameras and simulated data from a first principle physics-based model;
determine optimized fuel coefficients A and B corresponding to different LHVs based on the collected historical data, the ground truth DRE data, and the simulated data;
generate lookup table including the optimized fuel coefficients A and B corresponding to the different LHVs; and
train an AI/ML model based on the collected historical data, the ground truth DRE data, the simulated data, and the lookup table to generate the trained AI/ML model.

18. The non-transitory machine-readable information storage medium of claim 17, wherein the AI/ML model is trained to learn patterns from the real-time flare data, the historical data, the ground truth DRE data, the simulated data, and the lookup table corresponding to the plurality of flare stacks.

19. The non-transitory machine-readable information storage medium of claim 16, wherein the at least one processor is configured to generate one or more alerts when the DRE falls below the predetermined threshold.

20. The non-transitory machine-readable information storage medium of claim 16, wherein the at least one processor is configured to:
determine whether the predicted DRE falls below the predetermined threshold; and
adjust, using the trained AI/ML model, the one or more operational parameters to increase the DRE above the predetermined threshold.
